(19) United States
(12) Patent Application Publication
(10) Pub. No.: US 2006/0106962 A1
(43) Pub. Date: May 18, 2006

(54) USB On-The-Go implementation

(76) Inventors: Nancy G. Woodbridge, Austin, TX (US); Enrique Rendon, Pflugerville, TX (US); Mark N. Fullerton, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/992,250

(22) Filed: Nov. 17, 2004

(51) Int. Cl. G06F 13/42

(52) U.S. Cl. 710/106

(57) ABSTRACT

In some embodiments a Universal Serial Bus On-The-Go (USB OTG) device includes a USB device controller, a USB host controller, a USB OTG transceiver, and a controller to control a coupling between the USB device controller, the USB host controller, and the USB OTG transceiver, and to control whether the USB device controller, the USB host controller, or a combination of the USB device controller and the USB host controller controls the USB OTG transceiver. Other embodiments are described and claimed.

### TECHNICAL FIELD

The inventions generally relate to implementing Universal Serial Bus (USB) On-The-Go (OTG) operation using independent USB host and device controllers.

### BACKGROUND

Serial buses are now used to interface peripheral devices to a computer system. Examples of these buses include the Universal Serial Bus (USB) and the Institute of Electrical and Electronic Engineers (IEEE) 1394 standard bus. These serial buses provide a simple method of attaching and accessing peripheral devices.

For example, the USB is a new standard that complements the traditional interfaces via the microprocessor bus such as the Peripheral Component Interconnect (PCI), Industry Standard Architecture (ISA), or Enhanced Industry Standard Architecture (EISA) buses. Advantages of the USB include plug and play support, hot attachment, expandability, legacy hardware and software support, and low cost.

A USB-based system typically includes one or more USB clients, a USB host controller, one or more hubs, and several USB devices. Examples of USB devices are USB-compatible digital cameras, printers, keyboards, scanners, modems, and digital phones. All USB devices attach directly to a USB controller or via a USB hub that provides one or more ports. Original USB (USB 1.1) supports two different speeds: 1.5 megabits (Mbits) per second (Mbps) for low-speed devices and 12 MBits/second (Mbps) for high-speed devices. USB 2.0 (Hi-Speed USB) supports a speed of 480 Mbps.

USB makes plugging in new peripherals easy with plug and play, is much faster (approximately 100 times faster) than the original serial port, and supports multiple device connectivity. Because of these benefits, USB is enjoying broad market acceptance. USB allows expandability of the capabilities of a computer via an external port, eliminating the need for users or integrators to open the system chassis. Since USB supports multiple peripheral devices simultaneously, it allows users to run numerous devices such as printers, scanners, digital cameras and speakers from a single computer (for example, a PC). USB also allows for automatic device detection and installation, making connectivity a true plug-and-play experience for end users. Virtually every PC today has one or more USB ports, quickly moving the installed base of USB-capable PCs to the range of hundreds of millions.

Portable computing products such as handhelds, cell phones and digital cameras that have previously connected to a host such as a PC, as a USB peripheral, can benefit from having additional capability of connecting to other USB devices (for example, a digital camera connecting directly to a printer to print pictures directly from the camera, a cell phone connecting directly to a monitor or display device for wireless internet capability, or a cell phone connecting directly to a portable MP3 player, etc.) USB On-The-Go (USB OTG) defines a way for portable devices, through only one mini-connector, to connect to supported USB products in addition to a PC. USB OTG is a new supplement to the USB 2.0 specification that augments the capabilities of existing mobile devices and USB peripherals by adding host functionality for connection to USB peripherals.

USB OTG functionality has been outlined, for example, in “On-The-Go Supplement to the USB 2.0 Specification, Revision 1.0a” dated Jun. 24, 2003. Since USB has traditionally consisted of a host-peripheral topology where the PC was the host and the peripheral (or client device) was a relatively dumb device, new features were needed to upgrade standard USB technology for mobile devices using USB OTG technology. The new features of USB OTG include, for example, a new standard for small form factor USB connectors and cables, the addition of host capabilities to products that have traditionally only been peripherals in order to enable point-to-point connections, the ability of the device to be either a host or a peripheral (that is, dual-role devices) and to dynamically switch between the two, and lower power requirements to facilitate USB on battery powered devices.

In order to perform USB OTG, a device needs to include USB host control, USB device control (USB peripheral control), and USB On-The-Go control. Therefore, the present inventors have recognized that it would be advantageous for a USB device to be able to have three different capabilities, the capability to function as a USB host, the capability to function as a USB client device, and the capability to operate as a USB OTG device. The present inventors have also recognized that it would be advantageous to perform USB OTG in a manner that includes all three of these capabilities but does not require three modules, including a USB host controller, a USB device controller, and a separate USB On-The-Go controller that is a combination of a USB host controller and a USB device controller.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a Universal Serial Bus On-The-Go (USB OTG) implementation according to some embodiments of the inventions.

FIG. 2 illustrates an implementation according to some embodiments of the inventions.

### DETAILED DESCRIPTION

Some embodiments of the inventions relate to implementing Universal Serial Bus (USB) On-The-Go (OTG) operation using independent USB host and device controllers.

In some embodiments a Universal Serial Bus On-The-Go (USB OTG) device includes a USB device controller, a USB host controller, a USB OTG transceiver, and a controller to control a coupling between the USB device controller, the USB host controller, and the USB OTG transceiver, and to control whether the USB device controller, the USB host controller, or a combination of the USB device controller and the USB host controller controls the transceiver.

In some embodiments a Universal Serial Bus device includes a USB device controller, a USB host controller, a transceiver, and a controller to control a coupling between the USB device controller, the USB host controller, and the transceiver, and to control whether the USB device controller, the USB host controller, or a combination of the USB device controller and the USB host controller controls the transceiver.

In some embodiments an apparatus includes a device controller, a host controller, a transceiver, and a controller to control a coupling between the device controller, the host controller, and the transceiver, and to control whether the device controller, the host controller, or a combination of the device controller and the host controller controls the transceiver.

In some embodiments a USB On-The-Go device includes an integrated circuit, an external charge pump, and an external transceiver. The integrated circuit includes a USB device controller, a USB host controller, a USB On-The-Go transceiver, an I/O interface to couple the integrated circuit to the external charge pump and to the external transceiver, and a controller to control a coupling between the USB device controller, the USB host controller, the I/O interface, and the USB On-The-Go transceiver, and to control whether the USB device controller, the USB host controller, or a combination of the USB device controller and the USB host controller controls the transceiver.

In some embodiments a system includes a first USB device, a second USB device, and a USB cable coupling the first USB device and the second USB device. The first USB device is a USB On-The-Go device including an integrated circuit, an external charge pump, and an external transceiver. The integrated circuit includes a USB device controller, a USB host controller, a USB On-The-Go transceiver, an I/O interface to couple the integrated circuit to the external charge pump and to the external transceiver, and a controller to control a coupling between the USB device controller, the USB host controller, the I/O interface, and the USB On-The-Go transceiver, and to control whether the USB device controller, the USB host controller, or a combination of the USB device controller and the USB host controller controls the USB On-The-Go transceiver.

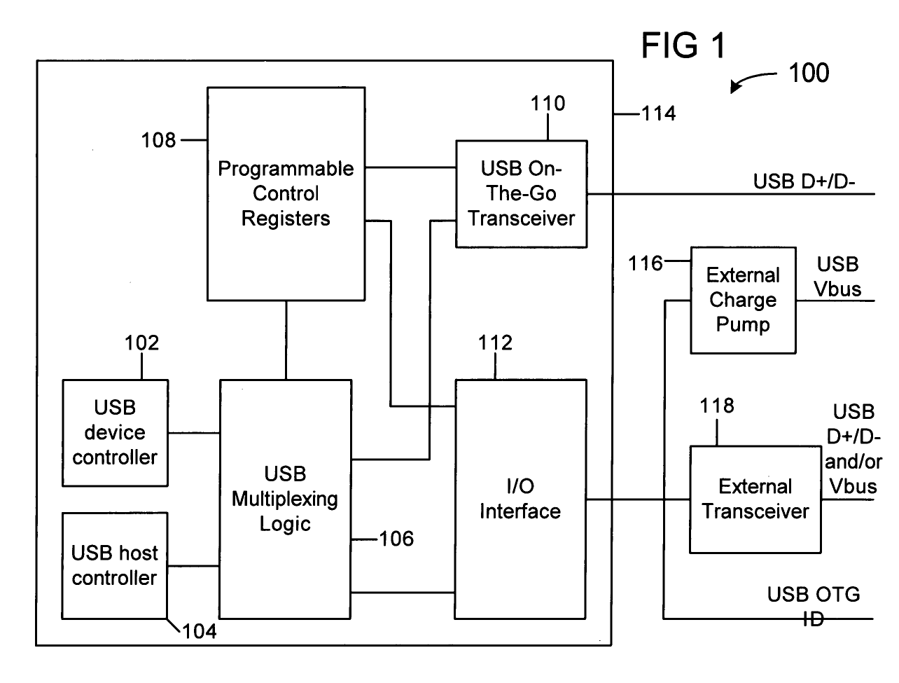

FIG. 1 illustrates a Universal Serial Bus On-The-Go (USB OTG) implementation 100 according to some embodiments. In some embodiments implementation 100 is included in a USB device (for example, a USB OTG device). In some embodiments the USB OTG implementation illustrated in FIG. 1 allows a user to configure a single on-chip USB host controller and USB device controller to be used either individually or together for USB On-The-Go operation without requiring a separate on-the-go controller. Although the implementation illustrated in FIG. 1 is related to a USB OTG implementation it is noted that some embodiments are not limited to USB or to USB On-The-Go. In some embodiments a USB device controller and a USB host controller could be used to control a USB transceiver in a manner that allows either USB device or USB host control. In some embodiments a device controller and a host controller could be used to control a transceiver in a manner that allows either device or host control, and is not limited to USB operation.

In some embodiments implementation 100 includes a USB device controller 102, a USB host controller 104, USB signal multiplexing 106, user programmable control registers 108, a USB On-The-Go transceiver 110, and an Input/Output (I/O) interface 112. In some embodiments USB device controller 102, USB host controller 104, USB signal multiplexing 106, user programmable control registers 108, USB On-The-Go transceiver 110, and Input/Output (I/O) interface 112 are included on a single integrated circuit 114. In some embodiments integrated circuit 114 is an applications processor chip. However, in some embodiments USB device controller 102, USB host controller 104, USB signal multiplexing 106, user programmable control registers 108, USB On-The-Go transceiver 110, and Input/Output (I/O) interface 112 are not included in a single integrated circuit. In some embodiments implementation 100 can also include an external charge pump 116 and/or an external transceiver 118. In some embodiments implementation 100 is included in a device to allow the device to operate as either a host and/or a client. In some embodiments implementation 100 is included in a USB device to allow the USB device to operate as a host, as a client, and/or in a USB On-The-Go mode.

In some embodiments USB device controller 102 is an existing unmodified USB device controller. In some embodiments USB device controller 102 is a USB 1.1 device controller. In some embodiments where USB device controller 102 is a USB 1.1 device controller, the device is modified to detect USB OTG commands, since a standard USB 1.1 device sends the wrong response to USB OTG commands if not modified to decode them. In some embodiments USB device controller 102 is a USB 2.0 device controller. In some embodiments USB host controller 104 is an existing unmodified USB host controller. In some embodiments USB host controller 104 is a USB 1.1 host controller. In some embodiments where USB host controller 104 is a USB 1.1 host controller, the host controller is modified to send USB OTG commands. In some embodiments USB host controller 104 is a USB 2.0 host controller. In some embodiments USB device controller 102 and USB host controller 104 are independent USB host and device controllers. In some embodiments USB multiplexing logic 106 can be a multiplexer (MUX) or any other type of device that allows multiplexing to occur (for example, any type of signal multiplexing or multiplexing logic). In some embodiments user programmable control registers 108 can be user programmable, can be implemented in software, hardware and/or firmware, can provide any type of control, and/or need not be limited to being programmable or responsive to any user input. In some embodiments USB multiplexing logic 106 can be any combinational logic to massage signals to perform the functions outlined herein. In some embodiments controller 108 controls if USB host controller 104 or USB device controller 102 is the master of the USB On-The-Go transceiver 110 and/or controls ports that enable communication with other USB connections (for example, USB D+/D− ports, Vbus ports, and/or USB OTG ID ports). In some embodiments this control 108 is in response to user input. In some embodiments this control 108 is programmable. In some embodiments this control 108 is implemented using control registers. In some embodiments this control 108 is implemented in software. In some embodiments this control 108 is implemented in firmware and/or hardware. In some embodiments USB On-The-Go transceiver 110 can be any type of transceiver, including a USB transceiver that is not a USB On-The-Go transceiver, and/or any other type of transceiver. In some embodiments, transceiver 110 is coupled to pull-up and pull-down resistors on D+/D−. In some embodiments I/O interface 112 can be any type of I/O interface. In some embodiments I/O interface 112 is a General Purpose Input/Output interface (GPIO interface). In some embodiments I/O interface 112 is an I²C interface. In some embodiments external charge pump 116 is coupled to the I/O interface 112, and provides an output Vbus signal. In some embodiments external transceiver 118 is coupled to the I/O interface 112, and provides a USB D+/D− signal and/or a Vbus signal. In some embodiments a charge pump is included within external transceiver 118. In some embodiments a USB OTG ID signal is coupled to I/O interface 112. In some embodiments the USB OTG ID signal is a bit that informs each end of a USB OTG connection whether that end is supposed to start as a host or a client device (similar to a reset configuration bit, for example).

Further information about USB and USB OTG related signals such as pull-up and pull-down resistors on D+/D−, USB D+/D− signals, USB Vbus signal, USB OTG ID signal and/or other USB and/or USB OTG related signals and/or other USB and/or USB OTG related information are explained in the Universal Serial Bus Specification, Revision 2.0, dated Apr. 27, 2000 and in the On-The-Go Supplement to the USB 2.0 Specification, Revision 1.0a, Jun. 24, 2003.

In some embodiments the user programmable control registers 108 provide controllability of pull-up and pull-down resistors on D+/D− coupled to the USB on-the-go transceiver 110, control of the multiplexing 106 between the device controller 102 and the host controller 104 to the on-die transceiver 110 and/or between the device controller 102 and the host controller 104 to the input/output interface 112, interface to the USB ID pin, and/or interface to the external charge pump 116 and/or the external transceiver 118 (and/or other external transceiving devices). In some embodiments these control operations are performed using software control.

In some embodiments a user selects to use either the on-die transceiver 110 with an external charge pump 116, or to use an external transceiver 118. If the user selects to use the on-die transceiver 110 with the external charge pump 116, the I/O interface 112 (for example, a GPIO interface or an I²C interface) provides the interface to the charge pump 116 to allow the user to detect USB OTG sessions and to read the USB OTG ID pin. When OTG events are detected, interrupts are sent to the core of the integrated circuit 114 (for example, to the controller/control registers 108) to allow the user to control the multiplexing and I/O pins as required. If the user selects to use the external transceiver 118, the I/O interface 112 (for example, GPIO interface and/or I²C interface) is used to interface to the external transceiver 118. Once again, interrupts are sent to the core of the integrated circuit 114 when OTG events are detected, allowing the user to control the multiplexing and the I/O pins as required. In this case, in some embodiments, the on-die transceiver 110 can be used as a dedicated USB host controller transceiver or as a dedicated USB device controller transceiver.

In some embodiments, the programmable control registers 108 allow the user to enable the USB device controller 102 data to be output on either the USB OTG transceiver 110 or to the I/O interface 112. The controller registers 108 also allow the user to enable USB host controller 104 data to be output on either the USB OTG transceiver 110 or to the I/O interface 112. If the USB device controller 102 is using the USB OTG transceiver 110 then the user can enable the USB host controller 104 to use the I/O interface 112 and vice versa. If both USB device controller 102 and USB host controller 104 are assigned to a separate interface (either the I/O interface 112 or the transceiver 110), then they are working in non-OTG mode. In some embodiments, the multiplexer 106 has logic in it that controls the source of the data for the transceiver 110 and the I/O control 112. When the user wants to use the USB device controller 102 and the USB host controller 104 in OTG mode, then the user selects either the transceiver 110 or the I/O interface 112 as the I/O source and then multiplexes between USB device controller 102 and USB host controller 104 on the same interface. This selection is done in response to the OTG ID pin, and then also in response to the detection of commands and status from the USB. In the case where the user is running in OTG mode, the other interface (the one not selected as the connection to the bus or external device) is idle. There may be two multiplexers included in the USB multiplexing logic 106, one multiplexer for transceiver 110 and one multiplexer for I/O interface 112. If the user is running in non-OTG mode, then both transceiver 110 and I/O interface 112 may be active with one attached to the USB device and the other attached to the USB host. When running in OTG mode only one (either transceiver 110 or I/O interface 112) will be active and the USB multiplexing logic 106 will select between the USB host and the USB client as the source and sink of the USB data. Programmable control register 108 provide control for selection between USB host controller 104 and USB device controller 104 as the source and sink of the USB data.

In some embodiments, an existing USB device controller 102 and existing USB host controller 104 are used without any necessary modifications to implement On-The-Go operation as well as still allowing the USB device controller 102 and the USB host controller 104 to be used individually. In some embodiments, the USB device controller 102 must be modified to decode the OTG commands so that it can be used for OTG operation. This modification can be implemented through simple additions that do not require the re-designing of the USB device controller. Additionally, in some embodiments a user may use either an external charge pump 116 and an on-die transceiver 110, or may use an external transceiver 118 in a manner such that the on-die transceiver 110 may be used for either USB device controller or USB host controller operation.

In some embodiments a single on-chip USB device controller and USB host controller are configured to be used either individually or together for On-The-Go operation. All three capabilities (USB device, USB host, and USB On-The-Go) may be implemented using two fundamental modules (USB device controller module and USB host controller module) in a manner that allows the two modules to be tied together (or multiplexed together) to provide USB On-The-Go operation. This is implemented without requiring three separate modules (that is, a USB device controller, a USB host controller, and a separate USB On-The-Go controller that is a combination of the USB device controller and the USB host controller). This implementation does not require that any existing USB device controller and USB host controller modules be re-designed. In some embodiments as many elements of FIG. 1 as possible can be off-the-shelf elements or modules. For example, an off-the-shelf general purpose I/O interface (GPIO) can be used to implement interface 112 to couple to selected off-chip devices such as an external charge pump and/or an external transceiver, etc.

In some embodiments the implementation 100 is included in a device that is coupled to one or more other devices. In some embodiments the implementation 100 is included in a USB device (for example, a USB OTG device) that is coupled to one or more other USB devices. In some embodiments, one or more of these other USB devices are USB OTG devices.

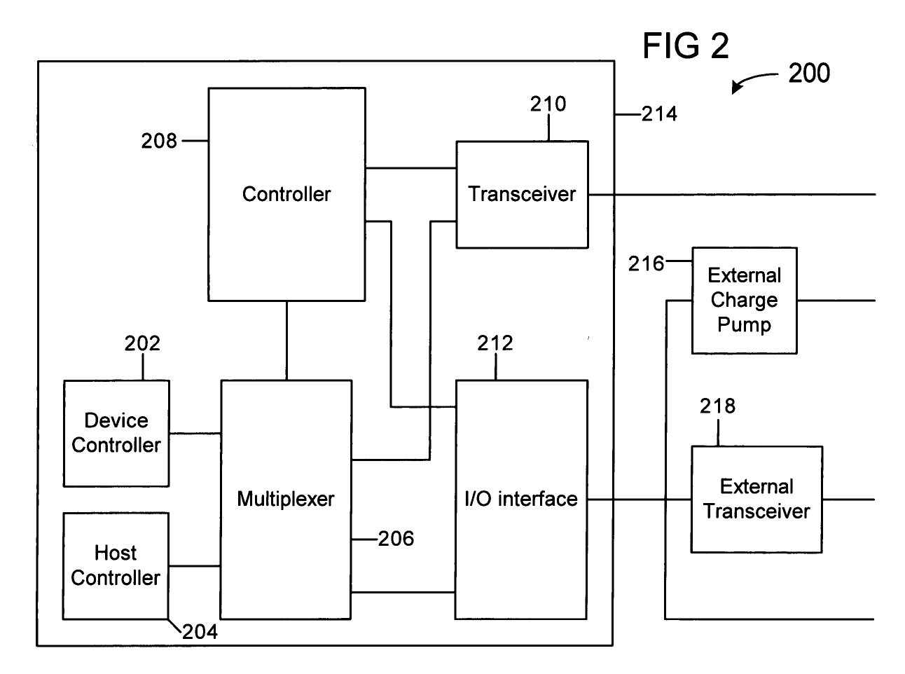

FIG. 2 illustrates an implementation 200 according to some embodiments. Implementation 200 can perform USB and/or USB OTG functions, but is not necessarily limited to USB or USB OTG. In some embodiments implementation 200 is included in a device. In some embodiments the implementation illustrated in FIG. 2 allows a user to configure a host controller and a device controller to be used either individually or together without requiring a separate controller that includes both device and host controller functionality. In some embodiments a device controller and a host controller could be used to control a transceiver in a manner that allows either device or host control.

In some embodiments implementation 200 includes a device controller 202, a host controller 204, a multiplexer 206, a controller 208, a transceiver 210, and an I/O interface 212. In some embodiments device controller 202, host controller 204, multiplexer 206, controller 208, transceiver 210, and I/O interface 212 are included on a single integrated circuit 214. In some embodiments integrated circuit 214 is an applications processor chip. However, in some embodiments device controller 202, host controller 204, multiplexer 206, controller 208, transceiver 210, and I/O interface 212 are not included in a single integrated circuit. In some embodiments implementation 200 can also include an external charge pump 216 and/or an external transceiver 218. In some embodiments implementation 200 is included in a device to allow the device to operate as either a host and/or a client. In some embodiments implementation 200 is included in a USB device to allow the USB device to operate as a host, as a client, and/or in a USB On-The-Go mode. In some embodiments implementation 200 can be an implementation performing similar or the same functions as the implementation 100 of FIG. 1, and can perform USB functions, USB OTG functions, or non-USB functions, for example. In some embodiments device controller 202, host controller 204, multiplexer 206, controller 208, transceiver 210, I/O interface 212, integrated circuit 214, external charge pump 216 and/or transceiver 218 can perform similar functions or the same functions as USB device controller 102, USB host controller 104, USB signal multiplexing 106, user programmable control registers 108, USB On-The-Go transceiver 110, and Input/Output (I/O) interface 112, integrated circuit 114, external charge pump 116, and/or transceiver 118, respectively, and can perform USB functions, USB OTG functions, or non-USB functions, for example.

In some embodiments user controller 208 can be user programmable, can be implemented in software, hardware and/or firmware, can provide any type of control, and/or need not be limited to being programmable or responsive to any user input. In some embodiments multiplexer 206 can be any combinational logic to massage signals to perform the functions outlined herein. In some embodiments controller 208 controls if host controller 204 or device controller 202 is the master of the transceiver 210 and/or controls ports that enable communication with other connections (for example, output from transceiver 210, I/O interface 212, external charge pump 216, and/or external transceiver 218). In some embodiments controller 208 is in response to user input. In some embodiments controller 208 is programmable. In some embodiments controller 208 is implemented using control registers. In some embodiments this controller 208 is implemented in software. In some embodiments this controller 208 is implemented in firmware and/or hardware. In some embodiments transceiver 210 can be any type of transceiver, including a USB transceiver, a USB On-The-Go transceiver, a USB transceiver that is not a USB On-The-Go transceiver, and/or any other type of transceiver. In some embodiments I/O interface 212 can be any type of I/O interface. In some embodiments I/O interface 212 is a General Purpose Input/Output interface (GPIO interface). In some embodiments I/O interface 212 is an I²C interface. In some embodiments external charge pump 216 is coupled to the I/O interface 212. In some embodiments external transceiver 218 is coupled to the I/O interface 212. In some embodiments a charge pump is included within external transceiver 218. In some embodiments the signal provided from I/O interface 212 as an output (signal shown below the external transceiver 218) is one or more bits that inform each connected device end whether that end is supposed to start as a host or a client device (similar to a reset configuration bit, for example).

In some embodiments the controller 208 provides controllability of the output of transceiver 210, control of the multiplexing 206 between the device controller 202 and the host controller 204 to the on-die transceiver 210 and/or between the device controller 202 and the host controller 204 to the input/output interface 212, interface to the output signal of the I/O interface 212, and/or interface to the external charge pump 216 and/or the external transceiver 218. In some embodiments these control operations are performed using software control.

In some embodiments a user selects to use either the on-die transceiver 210 with an external charge pump 216, or to use an external transceiver 218. If the user selects to use the on-die transceiver 210 with the external charge pump 216, the I/O interface 212 (for example, a GPIO interface or an I²C interface) provides the interface to the charge pump 216 to allow the user to detect input on any of the pins output from interface 212. In some embodiments, when events are detected on one or more of these pins, interrupts are sent to the core of the integrated circuit 214 (for example, to controller 208) to allow the user to control the multiplexer 206 and I/O pins output from interface 212 as required. If the user selects to use the external transceiver 218, the I/O interface 212 (for example, GPIO interface and/or I²C interface) is used to interface to the external transceiver 218. Once again, interrupts are sent to the core of the integrated circuit 214 (for example, to controller 208) when connection events are detected, allowing the user to control the multiplexer 206 and the I/O pins output from interface 212 as required. In this case, in some embodiments, the on-die transceiver 210 can be used as a dedicated host controller transceiver or as a dedicated device (client) controller transceiver.

In some embodiments, an existing device controller 202 and existing host controller 204 are used without any necessary modifications to combined operation as well as still allowing the device controller 202 and the host controller 204 to be used individually. Additionally, in some embodiments a user may use either an external charge pump 216 and an on-die transceiver 210, or may use an external transceiver 218 in a manner such that the on-die transceiver 210 may be used for either device controller or host controller operation.

In some embodiments a single on-chip USB device controller and USB host controller are configured to be used either individually or together. All three capabilities (client/device, host, and combined operation) may be implemented using two fundamental modules (device controller module and host controller module) in a manner that allows the two modules to be tied together (or multiplexed together) to provide a combined operation. This is implemented without requiring three separate modules (that is, a device controller, a host controller, and a separate combined controller that is a combination of the device controller and the host controller). This implementation does not require that any existing device controller and host controller modules be re-designed. In some embodiments as many elements of FIG. 2 as possible can be off-the-shelf elements or modules. For example, an off-the-shelf general purpose I/O interface (GPIO) can be used to implement interface 212 to couple to selected off-chip devices such as an external charge pump and/or an external transceiver, and/or another device, etc. In some embodiments the implementation 200 is included in a device that is coupled to one or more other devices.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A USB device comprising:
a USB device controller;
a USB host controller;
a transceiver; and
a controller to control a coupling between the USB device controller, the USB host controller, and the transceiver, and to control whether the USB device controller, the USB host controller, or a combination of the USB device controller and the USB host controller controls the transceiver.

2. The USB device according to claim 1, wherein the USB device is a USB On-The-Go device.

3. The USB device according to claim 2, wherein the transceiver is a USB On-The-Go transceiver.

4. The USB device according to claim 1, wherein the transceiver is a USB On-The-Go transceiver.

5. The USB device according to claim 1, wherein the USB device controller, the USB host controller, the transceiver and the controller are all included in the same integrated circuit.

6. The USB device according to claim 1, further comprising a multiplexer to multiplex the coupling in response to the controller.

7. The USB device according to claim 1, further comprising an I/O interface to couple the controller to other devices.

8. The USB device according to claim 7, wherein the other devices include an external charge pump and an external transceiver.

9. The USB device according to claim 1, wherein the USB device is to perform USB On-The-Go operation by using the transceiver and the external charge pump.

10. The USB device according to claim 1, wherein the USB device is to perform USB On-The-Go operation using the external transceiver.

11. The USB device according to claim 10, wherein the transceiver is to perform as a dedicated host controller transceiver.

12. The USB device according to claim 10, wherein the transceiver is to perform as a dedicated device controller transceiver.

13. The USB device according to claim 1, wherein in a first mode the USB device is to perform USB On-The-Go operation by using the transceiver and the external charge pump, and in a second mode the USB device is to perform USB On-The-Go operation using the external transceiver.

14. An apparatus comprising:
a device controller;
a host controller;
a transceiver; and
a controller to control a coupling between the device controller, the host controller, and the transceiver, and to control whether the device controller, the host controller, or a combination of the device controller and the host controller controls the transceiver.

15. The apparatus according to claim 14, wherein the device controller is a USB device controller and the host controller is a USB host controller.

16. The apparatus according to claim 14, wherein the device controller, the host controller, the transceiver and the controller are all included in the same integrated circuit.

17. The apparatus according to claim 14, further comprising a multiplexer to multiplex the coupling in response to the controller.

18. The apparatus according to claim 14, further comprising an I/O interface to interface the controller to other external devices.

19. The apparatus according to claim 18, wherein the other devices include an external charge pump and an external transceiver.

20. A USB On-The-Go device comprising:
an integrated circuit;
an external charge pump; and
an external transceiver;
the integrated circuit including:
a USB device controller;
a USB host controller;
a USB On-The-Go transceiver;
an I/O interface to couple the integrated circuit to the external charge pump and to the external transceiver; and
a controller to control a coupling between the USB device controller, the USB host controller, the I/O interface, and the USB On-The-Go transceiver, and to control whether the USB device controller, the USB host controller, or a combination of the USB device controller and the USB host controller controls the transceiver.

21. The USB On-The-Go device according to claim 20, the integrated circuit further comprising a multiplexer to multiplex the coupling in response to the controller.

22. The USB On-The-Go device according to claim 20, wherein the USB On-The-Go device is to perform USB On-The-Go operation by using the transceiver and the external charge pump.

23. The USB On-The-Go device according to claim 20, wherein the USB On-The-Go device is to perform USB On-The-Go operation using the external transceiver.

24. The USB On-The-Go device according to claim 23, wherein the USB On-The-Go transceiver is to perform as a dedicated USB host controller transceiver.

25. The USB On-The-Go device according to claim 23, wherein the USB On-The-Go transceiver is to perform as a dedicated USB device controller transceiver.

26. The USB On-The-Go device according to claim 20, wherein in a first mode the USB On-The-Go device is to perform USB On-The-Go operation by using the USB On-The-Go transceiver and the external charge pump, and in a second mode the USB On-The-Go device is to perform USB On-The-Go operation using the external transceiver.

27. A system comprising:
a first USB device;
a second USB device; and
a USB cable coupling the first USB device and the second USB device;
wherein the first USB device is a USB On-The-Go device including:
an integrated circuit;
an external charge pump; and
an external transceiver;
the integrated circuit including:
a USB device controller;
a USB host controller;
a USB On-The-Go transceiver;
an I/O interface to couple the integrated circuit to the external charge pump and to the external transceiver; and
a controller to control a coupling between the USB device controller, the USB host controller, the I/O interface, and the USB On-The-Go transceiver, and to control whether the USB device controller, the USB host controller, or a combination of the USB device controller and the USB host controller controls the USB On-The-Go transceiver.

28. The system according to claim 27, the integrated circuit further comprising a multiplexer to multiplex the coupling in response to the controller.

29. The system according to claim 27, wherein the first USB device is to perform USB On-The-Go operation by using the USB On-The-Go transceiver and the external charge pump.

30. The system according to claim 27, wherein the first USB device is to perform USB On-The-Go operation using the external transceiver.

31. The system according to claim 30, wherein the USB On-The-Go transceiver is to perform as a dedicated USB host controller transceiver.

32. The system according to claim 30, wherein the USB On-The-Go transceiver is to perform as a dedicated USB device controller transceiver.

33. The system according to claim 27, wherein in a first mode the first USB device is to perform USB On-The-Go operation by using the USB On-The-Go transceiver and the external charge pump, and in a second mode the first USB device is to perform USB On-The-Go operation using the external transceiver.

34. The system according to claim 27, wherein the second USB device is a USB On-The-Go device.
